(19) United States
(12) Patent Application Publication
(10) Pub. No.: US 2009/0231763 A1
(43) Pub. Date: Sep. 17, 2009

(54) OVER-VOLTAGE PROTECTION DEVICE

(75) Inventors: Pao Hsuan Chen, Taoyuan City (TW); David Shau Chew Wang, Taipei City (TW); Ching Han Yu, Fonglin Township (TW); Tong Cheng Tsai, Tainan City (TW)

Correspondence Address: CONNOLLY BOVE LODGE & HUTZ LLP, 1875 EYE STREET, N.W., SUITE 1100, WASHINGTON, DC, 20006, US

(73) Assignee: POLYTRONICS TECHNOLOGY CORPORATION, Hsinchu (TW)

(21) Appl. No.: 12/046,507

(22) Filed: Mar. 12, 2008

(51) Int. Cl. H02H 3/00; H02H 7/00

(52) U.S. Cl. 361/1

(57) ABSTRACT

An over-voltage protection device comprises a substrate having a first surface and a second surface, a first nonrectangular conductor having a first protrusion positioned on the first surface of the substrate, a second nonrectangular conductor having a second protrusion positioned on the first surface of substrate, at least one alignment block positioned on the second surface, and a variable impedance material positioned between the first protrusion and the second protrusion. Preferably, the second protrusion faces the first protrusion to form an arcing path from the first protrusion to the second protrusion.

### BACKGROUND OF THE INVENTION

(A) Field of the Invention

The present invention relates to an over-voltage protection device, and more particularly, to an over-voltage protection device including two nonrectangular conductors having protrusions where an arcing path is designed from one protrusion of one conductor to another protrusion of the other conductor.

(B) Description of the Related Art

Integrated circuits are externally fed with supply potentials and input signals to be processed and to have processed output signals received from them. In particular, the input signal terminals are very sensitive, since the conductor tracks that feed the potentials and signals lead directly to a gate terminal of an input switching stage. While the integrated circuit is being manually handled, or during the automated processing to solder the integrated circuit on a circuit board, there is risk that the sensitive input stage or output stage may be destroyed by electrostatic discharge. For instance, the human body may be electrostatically charged and then discharged via the terminals leading to the outside of the semiconductor component containing the integrated circuit.

Tools of automatic component-mounting machines or test equipment may also be electrostatically charged and discharged via the semiconductor component. As technology advances and the scale of pattern lines on the semiconductor body bearing integrated circuits becomes smaller, there is a need for protection against such electrostatic discharges. Integrated circuit devices are often provided with some protection against electrostatic discharge (ESD) with high input currents, such as electrical resistors connected in their input paths, thereby limiting the input current.

U.S. Pat. No. 6,642,297 discloses a composition for providing protection against electrical overstress (EOS) comprising an insulating binder, doped semiconductive particles, and semiconductive particles. The composite materials exhibit a high electrical resistance to normal operating voltage values, but in response to an EOS transient the materials switch to a low electrical resistance and limit the EOS transient voltage to a low level for the duration of the EOS transient.

U.S. Pat. No. 6,013,358 discloses a transient voltage protection device wherein a gap between a ground conductor and another conductor is formed using a diamond-dicing saw. Substrate material selection includes specific ceramic materials having a density of less than 3.8 gm/cm.sup.3 designed to optimize performance and manufacturability. An overlay layer can be provided to minimize burring of the conductors during formation of the gap.

U.S. Pat. No. 5,068,634 discloses a material and device for electronic circuitry that provides protection from fast transient over-voltage pulses. The electroded device can additionally be tailored to provide electrostatic bleed. Conductive particles are uniformly dispersed in an insulating matrix or binder to provide a material having non-linear resistance characteristics. The non-linear resistance characteristics of the material are determined by the inter-particle spacing within the binder as well as by the electrical properties of the insulating binder. By tailoring the separation between the conductive particles, thereby controlling quantum-mechanical tunneling, the electrical properties of the non-linear material can be varied over a wide range.

U.S. Pat. No. 6,498,715 discloses a stack up type low capacitance over-voltage protective device comprising a substrate, a conductive low electrode layer formed on the substrate, a voltage sensitive material layer formed on the conductive lower electrode layer, and a conductive upper electrode layer formed on the voltage sensitive material layer.

U.S. Pat. No. 6,645,393 discloses a material for transient voltage suppressors composed of at least two kinds of evenly-mixed powders including a powder material with non-linear resistance interfaces and a conductive powder. The conductive powder is distributed in the powder with non-linear resistance interfaces to relatively reduce the total number of non-linear resistance interfaces between two electrodes and, as a result, decrease the breakdown voltage of the components.

### SUMMARY OF THE INVENTION

One aspect of the present invention provides an over-voltage protection device including two nonrectangular conductors having protrusions where an arcing path is designed from one protrusion of one conductor to another protrusion of the other conductor.

An over-voltage protection device according to this aspect of the present invention comprises a substrate having a first surface and a second surface, a first nonrectangular conductor having a first protrusion positioned on the first surface of the substrate, a second nonrectangular conductor having a second protrusion positioned on the first surface of substrate, at least one alignment block positioned on the second surface, and a variable impedance material positioned between the first protrusion and the second protrusion. Preferably, the second protrusion faces the first protrusion to form an arcing path from the first protrusion to the second protrusion.

Conventional over-voltage protection devices all have two rectangular conductors with a gap between the two conductors of uniform width; therefore, the arcing path is unpredictable. In contrast, the present over-voltage protection device comprises the first nonrectangular conductor having the first protrusion and the second nonrectangular conductor having the second protrusion facing the first protrusion such that the distance between the first nonrectangular conductor and the second nonrectangular conductor is non-uniform. In particular, the gap between the first nonrectangular conductor and the second nonrectangular conductor is narrower at the protrusion portion than at other portions such that is the arcing path is designed to be at the protrusion portion and the variable impedance material covers the protrusion portion according to the embodiment of the present invention.

### BRIEF DESCRIPTION OF THE DRAWINGS

The objectives and advantages of the present invention will become apparent upon reading the following description and upon reference to the accompanying drawings in which:

FIG. 1 to FIG. 5 illustrate an over-voltage protection device according to one embodiment of the present invention;

FIG. 6 shows the relationship between the resistance and the applied voltage of the variable impedance material according to one embodiment of the present invention;

FIG. 7 shows the response of the over-voltage protection device as a transient voltage is applied according to one embodiment of the present invention; and

FIG. 8 illustrates an over-voltage protection device according to another embodiment of the present invention.

### DETAILED DESCRIPTION OF THE INVENTION

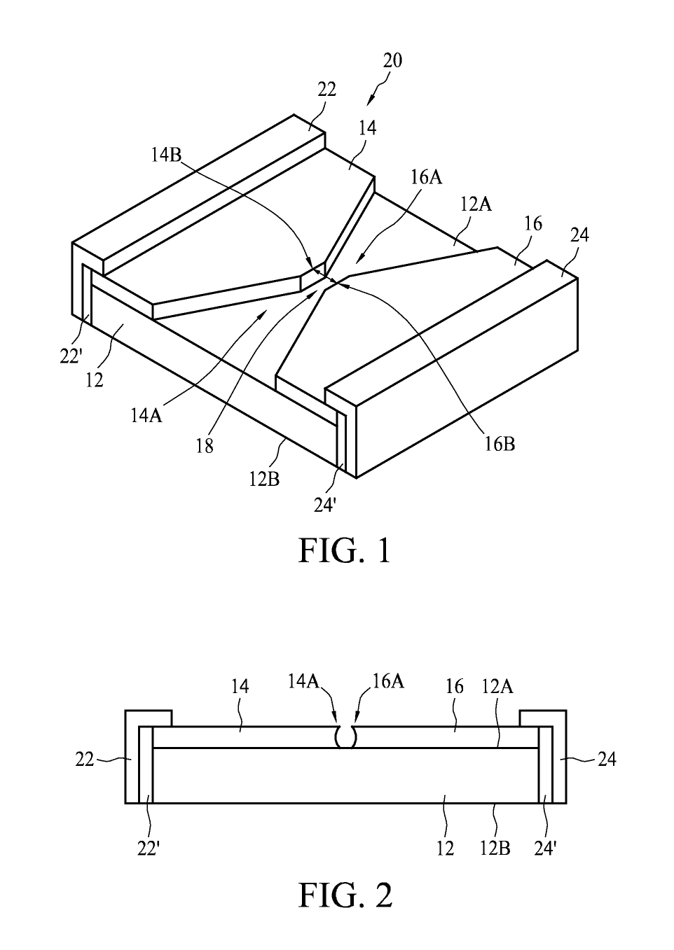

FIG. 1 to FIG. 5 illustrate an over-voltage protection device 10 according to one embodiment of the present invention. Referring to FIG. 1, an electrode structure 20 is formed on a substrate 12 made of insulation material such as plastic material, i.e., the substrate 12 is a plastic substrate having an upper surface 12A and a bottom surface 12B. The electrode structure 20 includes a first nonrectangular conductor 14 having a first protrusion 14A positioned on the upper surface 12A of the substrate 12, a second nonrectangular conductor 16 having a second protrusion 16A positioned on the upper surface 12A of the substrate 12, a first side-electrode 22 positioned on one side of the substrate 12 and connected to the first nonrectangular conductor 14, and a second side-electrode 24 positioned on the other side of the substrate 12 and connected to the second nonrectangular conductor 16.

In particular, a first conductive member 22′ is sandwiched between the substrate 12 and the first side-electrode 22, and a second conductive member 24′ is sandwiched between the substrate 12 and the second side-electrode 24. The first conductive member 22′ and the second conductive member 24′ can be plating metal layers or conductive through holes. Preferably, at least one of first protrusion 14A and the second protrusion 16A is a tapering protrusion with a tapering width. The second protrusion 16A faces the first protrusion 14A to form an arcing path 18 from the first protrusion 14A to the second protrusion 16A. Preferably, the first nonrectangular conductor 14 and the second nonrectangular conductor 16 are trapezoid and positioned on the substrate 12 in a mirror-image manner. In particular, the shape of the first nonrectangular conductor 14 can be different from that of the second nonrectangular conductor 16. The first protrusion 14A includes a first flat edge 14B and the second protrusion 16A includes a second flat edge 16B facing the first flat edge 14B.

Referring to FIG. 2, a cross-sectional view of the electrode structure 20. The widths of the first protrusion 14A and the second protrusion 16A at their upper portions is larger than the widths at their middle portions such that the first protrusion 14A and the second protrusion 16A have a non-uniform thickness. Consequently, the first protrusion 14A and the second protrusion 16A are closer at the upper portion than at the middle portion such that the arcing path 20 is formed between the upper portion of the first protrusion 14A and the upper portion of the second protrusion 16A.

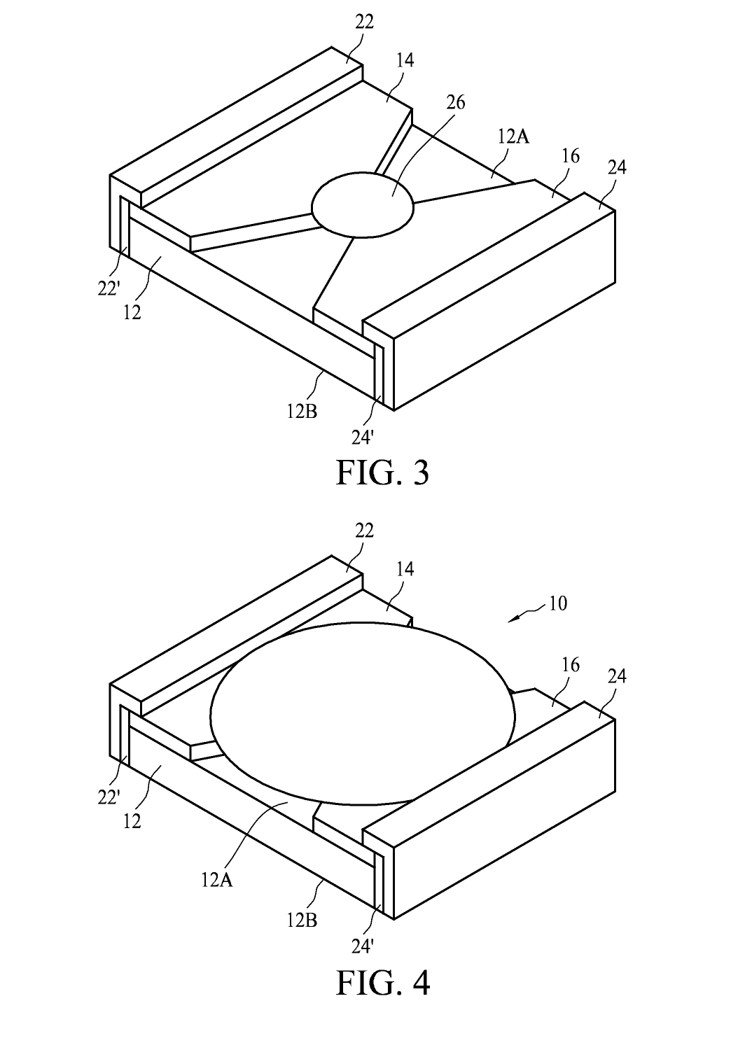

Referring to FIG. 3, a variable impedance material 26 is formed between the first protrusion 14A and the second protrusion 16A. Preferably, the variable impedance material includes a conductive powder in an amount from 10% to 30% of the weight of the variable impedance material, a semi-conductive powder in an amount from 30% to 90% of the weight of the variable impedance material, and an insulation adhesive in an amount from 3% to 50% of the weight of the variable impedance material.

Preferably, the conductive powder includes at least one element selected from the group consisting of Al, Ag, Pd, Pt, Au, Ni, Cu, W, Cr, Fe, Zn, Ti, Nb, Mo, Ru, Pb, and Ir, the semi-conductive powder includes zinc oxide or silicon carbide, and the insulation adhesive includes epoxy or silicone. In addition, the variable impedance material 28 may further include an insulation powder in an amount from 10% to 60% of the weight of the variable impedance material, and the insulation powder includes metal oxide such as aluminum oxide or zirconium oxide.

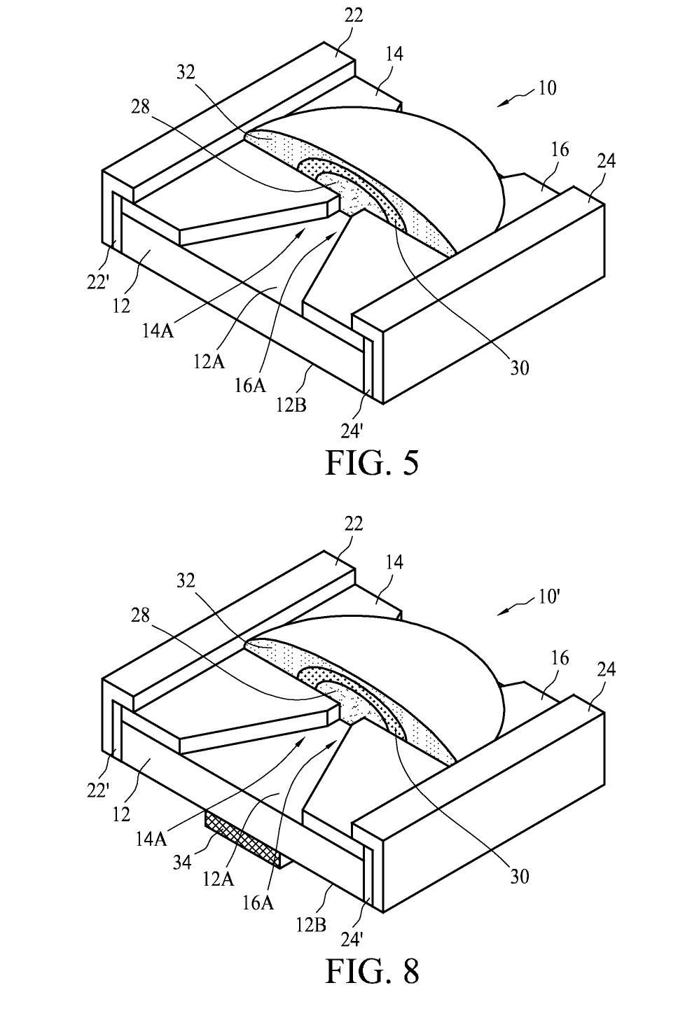

Referring to FIG. 4 and FIG. 5, an arc-protection layer 30 is formed to cover the variable impedance material 28, and an insulation layer 32 is then formed to cover the arc-protection layer 30 so as to complete the over-voltage protection device 10. Preferably, the arc-protection layer 30 include inorganic insulation material and organic insulation material, wherein the inorganic insulation material includes metal oxide and the organic insulation material includes epoxy or silicone. The insulation layer 32 includes inorganic insulation material and organic insulation material, wherein the inorganic insulation material includes metal oxide and the organic insulation material includes epoxy or silicone.

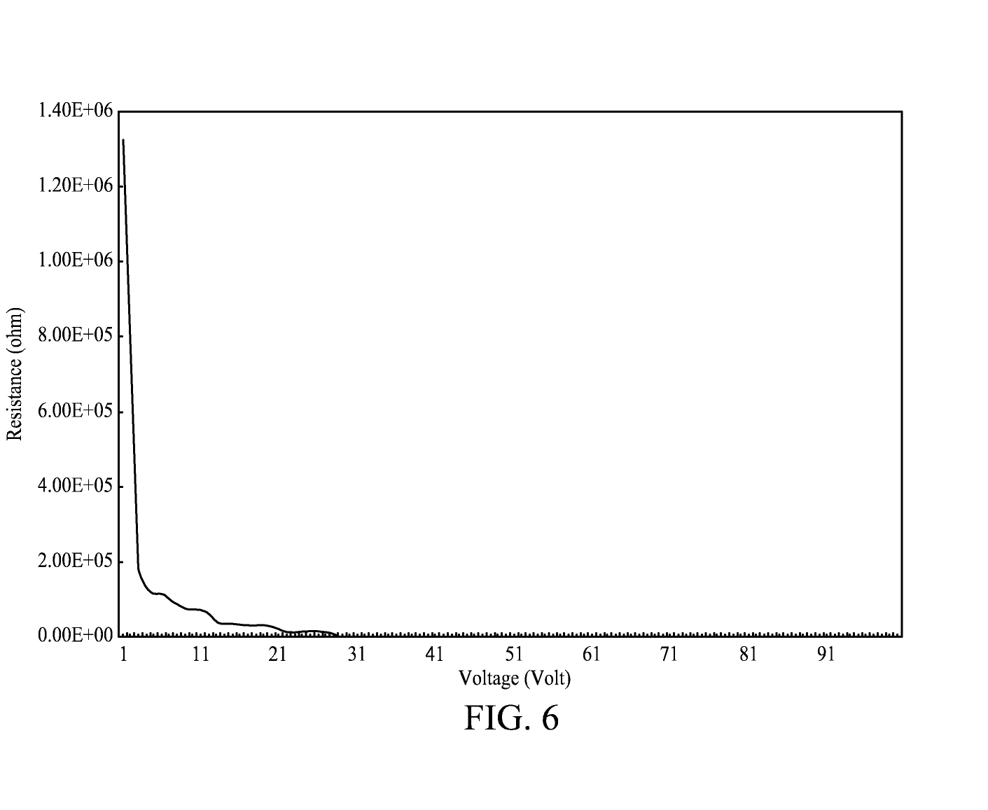

FIG. 6 shows the relationship between the resistance and the applied voltage of the variable impedance material 26 according to one embodiment of the present invention. Obviously, the variable impedance material 26 presents a high resistance at a low applied voltage and a low resistance at a high applied voltage. With the variable impedance material 26 positioned in the gap between the first nonrectangular conductor 14 and the second nonrectangular conductor 16, the over-voltage protection device 10 as a whole presents a high resistance to a low voltage applied across the gap and a low resistance to a high voltage applied across the gap.

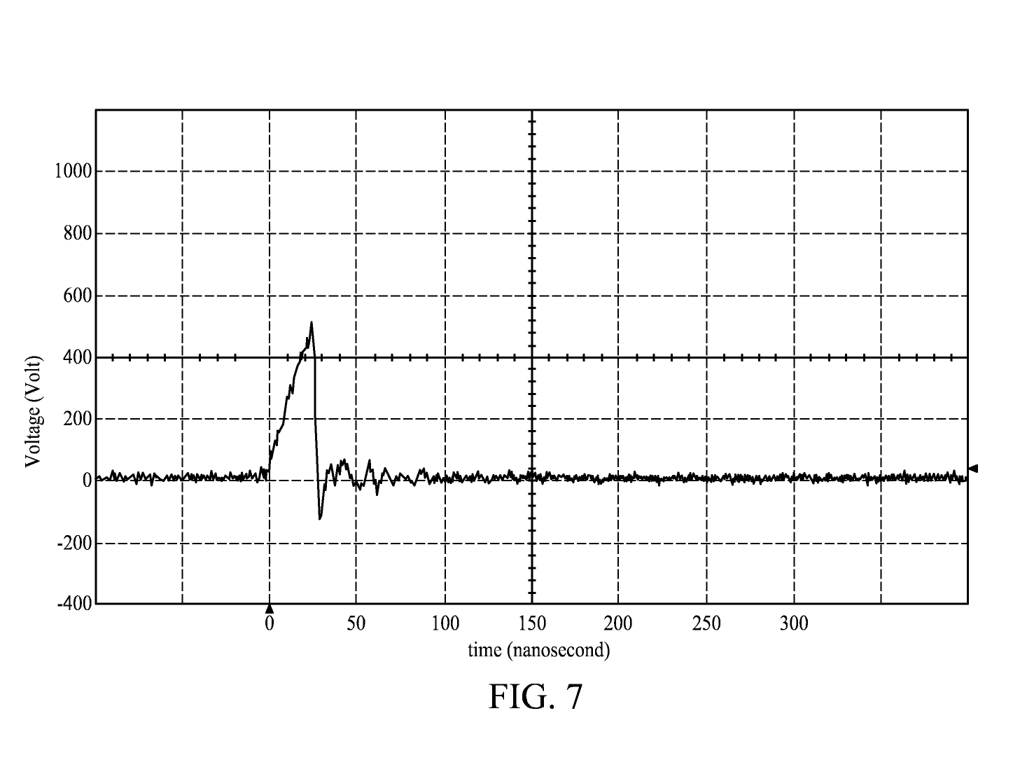

FIG. 7 shows the response of the over-voltage protection device 10 as a transient voltage is applied according to one embodiment of the present invention. The transient voltage of 1900 Volts is applied to the first nonrectangular conductor 14 and the second nonrectangular conductor 16, and the over-voltage protection device 10 switches to a low electrical resistance and limits the transient voltage of 1900 Volts to about 518 Volts. In other words, an electrical device connected to the over-voltage protection device 10 in parallel will not suffer transient voltage of 1900 Volts, but experiences a limited voltage about 518 Volts.

FIG. 8 illustrates an over-voltage protection device 10′ according to another embodiment of the present invention. Compared to the over-voltage protection device 10 shown in FIG. 5, The over-voltage protection device 10′ in FIG. 8 further comprises at least one alignment block 34 positioned on the bottom surface 12B of the substrate 12, and the alignment block 34 is configured to align to another alignment block on a circuit board (not shown in the drawing) when the over-voltage protection device 10′ is attaching to the circuit board. In addition, the alignment block 32 is not electrically connected to the conductive member of the over-voltage protection device 10′, and the number of the alignment block 32 can be optionally designed to be two or more.

Conventional over-voltage protection devices all have two rectangular conductors a gap between the two conductors of uniform width; therefore, the arcing path is unpredictable. In contrast, the present over-voltage protection device 10 comprises the first nonrectangular conductor 14 having the first protrusion 14A and the second nonrectangular conductor 16 having the second protrusion 16A facing the first protrusion 14A such that the distance between the first nonrectangular conductor 14 and the second nonrectangular conductor 16 is non-uniform. In particular, the gap between the first nonrectangular conductor 14 and the second nonrectangular conductor 16 is smaller at the protrusion portion than at other portions such that is the arcing path 18 is designed to be at the protrusion portion and the variable impedance material 26 covers the protrusion portion according to the embodiment of the present invention.

The above-described embodiments of the present invention are intended to be illustrative only. Numerous alternative embodiments may be devised by those skilled in the art without departing from the scope of the following claims.

What is claimed is:

1. An over-voltage protection device, comprising:
a substrate having a first surface and a second surface;
a first nonrectangular conductor having a first protrusion positioned on the first surface of the substrate;
a second nonrectangular conductor having a second protrusion positioned on the first surface of substrate, with the second protrusion facing the first protrusion to form an arcing path from the first protrusion to the second protrusion, wherein at least one of first protrusion and the second protrusion is a tapering protrusion; and
a variable impedance material positioned between the first protrusion and the second protrusion.

2. The over-voltage protection device of claim 1, wherein the first nonrectangular conductor and the second nonrectangular conductor are positioned on the substrate in a mirror-image manner.

3. The over-voltage protection device of claim 1, wherein the first protrusion includes a first flat edge and the second protrusion includes a second flat edge facing the first flat edge.

4. The over-voltage protection device of claim 1, wherein the first protrusion has a non-uniform thickness.

5. The over-voltage protection device of claim 1, wherein the width of the first protrusion at an upper portion is larger than the width at a middle portion.

6. The over-voltage protection device of claim 1, wherein the substrate is made of insulation material.

7. The over-voltage protection device of claim 1, wherein the substrate is a plastic substrate.

8. The over-voltage protection device of claim 1, further comprising a first side-electrode positioned on one side of the substrate and connected to the first nonrectangular conductor, and a second side-electrode positioned on the other side of the substrate and connected to the second nonrectangular conductor.

9. The over-voltage protection device of claim 8, further comprising a first conductive member sandwiched between the substrate and the first side-electrode and second conductive member sandwiched between the substrate and the second side-electrode.

10. The over-voltage protection device of claim 9, wherein the first conductive member and the second conductive member are plating metal layers or conductive through holes.

11. The over-voltage protection device of claim 1, wherein the first nonrectangular conductor and the second nonrectangular conductor are trapezoid.

12. The over-voltage protection device of claim 1, wherein the variable impedance material covers a portion of the first nonrectangular conductor and the second nonrectangular conductor.

13. The over-voltage protection device of claim 1, wherein the variable impedance material includes:
a conductive powder in an amount from 10% to 30% of the weight of the variable impedance material;
a semi-conductive powder in an amount from 30% to 90% of the weight of the variable impedance material; and
an insulation adhesive in an amount from 3% to 50% of the weight of the variable impedance material.

14. The over-voltage protection device of claim 13, wherein the conductive powder includes at least one element selected from the group consisting of Al, Ag, Pd, Pt, Au, Ni, Cu, W, Cr, Fe, Zn, Ti, Nb, Mo, Ru, Pb, and Ir.

15. The over-voltage protection device of claim 13, wherein the semi-conductive powder includes zinc oxide or silicon carbide.

16. The over-voltage protection device of claim 13, wherein the insulation adhesive includes epoxy or silicone.

17. The over-voltage protection device of claim 13, wherein the variable impedance material further includes an insulation powder in an amount from 10% to 60% of the weight of the variable impedance material.

18. The over-voltage protection device of claim 17, wherein the insulation powder includes metal oxide.

19. The over-voltage protection device of claim 18, wherein the metal oxide is aluminum oxide or zirconium oxide.

20. The over-voltage protection device of claim 1, further comprising an arc-protection layer covering the variable impedance material.

21. The over-voltage protection device of claim 20, wherein the arc-protection layer include inorganic insulation material and organic insulation material.

22. The over-voltage protection device of claim 21, wherein the inorganic insulation material includes metal oxide and the organic insulation material includes epoxy or silicone.

23. The over-voltage protection device of claim 20, further comprising an insulation layer covering the arc-protection layer.

24. The over-voltage protection device of claim 23, wherein the insulation layer includes inorganic insulation material and organic insulation material.

25. The over-voltage protection device of claim 24, wherein the inorganic insulation material includes metal oxide and the organic insulation material includes epoxy or silicone.

26. The over-voltage protection device of claim 1, further comprising at least one alignment block positioned on the second surface.

27. The over-voltage protection device of claim 26, wherein the alignment block is not electrically connected to conductive members of the over-voltage protection device.
